(19) United States
(12) Patent Application Publication
(10) Pub. No.: US 2002/0040969 A1
(43) Pub. Date: Apr. 11, 2002

(54) Apparatus and method for preventing the short circuit of a filament of a source head to a cathode

(76) Inventors: Sheng-Feng Hung, Taipei (TW); Hua-Jen Tseng, Hsinchu Hsien (TW); Chun-Chieh Lee, Hsinchu Hsien (TW); Dong-Tay Tsai, Kaohsiung (TW)

Correspondence Address: BIRCH STEWART KOLASCH & BIRCH, PO BOX 747, FALLS CHURCH, VA, 22040-0747, US

(21) Appl. No.: 09/970,925

(22) Filed: Oct. 5, 2001

(30) Foreign Application Priority Data
Oct. 6, 2000 (TW) 89120864

(51) Int. Cl. H01J 27/00

(52) U.S. Cl. 250/426

(57) ABSTRACT

Ion implantation equipment is modified so as to provide a support ring between the filament and the cathode where it can continue its function of insulating the filament, thereby greatly extending the lifetime and reducing downtime of the equipment. According to the present invention, apparatus for preventing the short circuit of a filament of a source head to a cathode, comprising: an arc chamber, having an opening; a cathode tube, through the opening of the arc chamber extending in the arc chamber, one end of the cathode tube having a hollow, the hollow facing outside of the arc chamber; an isolated support ring, locating in the hollow's sidewall of the cathode tube; and a filament, through the isolated support ring locating in the cathode tube.

### BACKGROUND OF THE INVENTION

1. Field of the Invention

The present invention relates to an ion source head, and more particularly to an apparatus for preventing the short circuit of a filament of a source head to a cathode.

2. Background

An ion beam of a preselected chemical species is generated is by means of a current applied to a filament within an ion source chamber, also fitted with a power supply, ion precursor gas feeds and controls. The ions are extracted through an aperture in the ion source chamber by means of a potential between the source chamber, which is positive, and extraction means.

FIG. 1 is a cross section view of the apparatus according to the prior art. A filament 100 extends into a cathode tube 102, is fixed outside the cathode tube 102 by a bolt or other fixed devices, and does not contact with the cathode tube 102. The cathode tube 102 is partially placed in an arc chamber 104. When power is fed to the filament 100, the filament 100 generates thermal electrons which bombard the cathode tube 102 and thus produce secondary electrons e-. The secondary electrons e- bombard target atoms resulting in ions such as P+, P++ and P+++. A repeller plate 106 is used for preventing the 30 secondary electrons form hitting the arc chamber and make more collisions of the secondary electrons e- with the target atoms.

The filament must be isolated with the cathode tube, but due to assembly error or expand by heat results in the short circuit of the filament to the cathode. The apparatus of the art increases the opportunity for faulty re-assembly and another cause of ion implant apparatus failure.

Thus a method of reducing or eliminating the danger of misalignment of the filament during re-assembly, and preventing the short circuit of the filament to the cathode, thereby extending the time between the need for servicing the arc chamber and reducing down time for the ion implanter, would be highly desirable.

### SUMMARY OF THE INVENTION

The object of the present invention is to solve the above-mentioned problems and to provide an apparatus for preventing the short circuit of a filament of a source head to a cathode. The apparatus of the invention has a support ring between the filament and the cathode where it can continue its function of insulating the filament. Thus the lifetime of the source head is greatly extended over conventional ion beam apparatus.

According to the present invention, apparatus for preventing the short circuit of a filament of a source head to a cathode, comprising: an arc chamber, having an opening; a cathode tube, through the opening of the arc chamber extending in the arc chamber, one end of the cathode tube having a hollow, the hollow facing outside of the arc chamber; an isolated support ring, locating in the hollow's sidewall of the cathode tube; and a filament, through the isolated support ring locating in the cathode tube.

### BRIEF DESCRIPTION OF THE DRAWINGS

The present invention will be described in detail with reference to the illustrated embodiments and the accompany drawings, in which:

FIG. 1 is a cross section view of the apparatus according to the prior art.

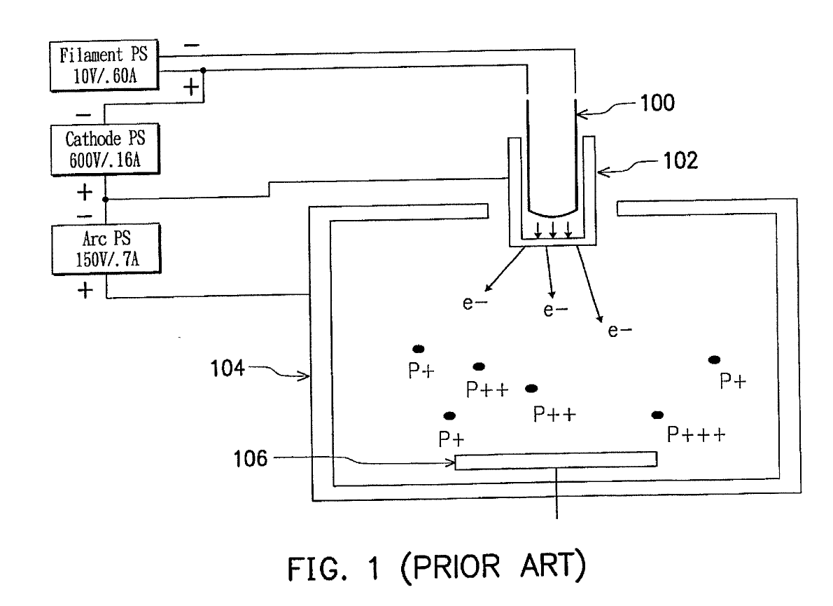

FIG. 2 is an exploded diagram of the apparatus in the preferred embodiment.

FIG. 3 is a cross section view of the apparatus in the preferred embodiment.

### DETAILED DESCRIPTION OF THE PREFERRED EMBODIMENT

An apparatus for preventing the short circuit of a filament of a source head to a cathode according to the preferred embodiment of the present invention will now be described.

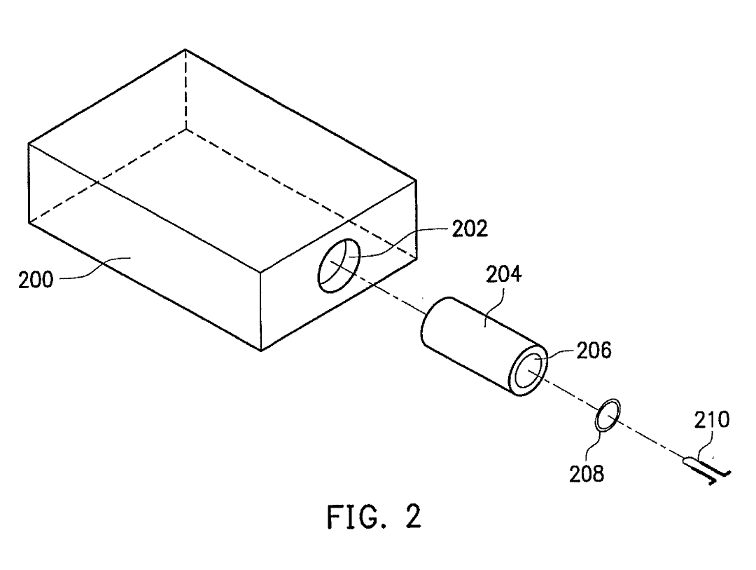

FIG. 2 is an exploded diagram of the apparatus in the preferred embodiment. As shown in FIG. 2, the apparatus includes an arc chamber 200 with an opening 202. A cathode tube 204 through the opening 202 of the arc chamber 200 extends in the arc chamber 200, one end of the cathode tube 204 has a hollow 206, the hollow 206 faces outside of the arc chamber 200. An isolated support ring 208 locates in the hollow's sidewall of the cathode tube 204. A material of the isolated support ring 208 is selected from the group consisting of glass, ceramic, polymer and combinations thereof. A shape of the isolated support ring 208 is selected from the group consisting of cylinder, trigonometry, rhombus and irregular. A filament 210 through the isolated support ring 208 locates in the cathode tube 204.

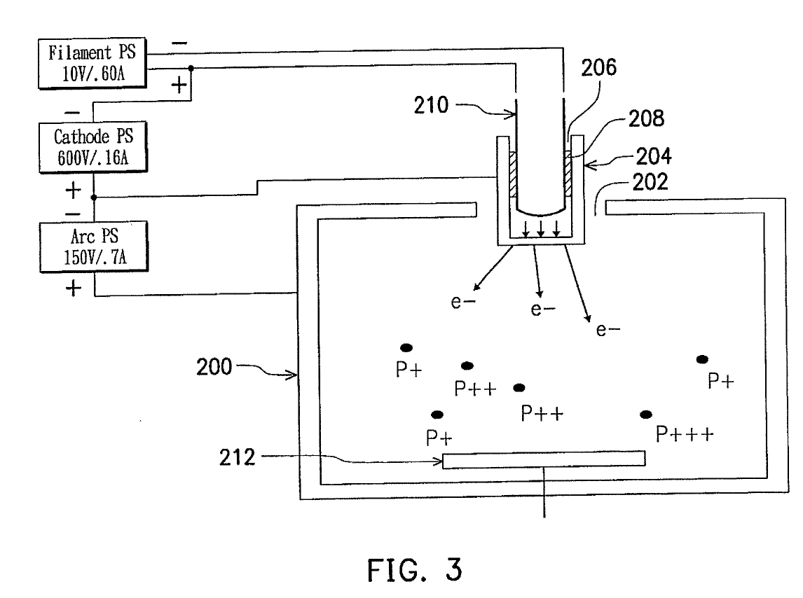

FIG. 3 is a cross section view of the apparatus in the preferred embodiment. The arc chamber 200 has the opening 202 for passage therethrough of the cathode tube 204. One end of the cathode tube 204 has the hollow 206, the hollow 206 faces outside of the arc chamber 200. The isolated support ring 208 locates in the hollow's sidewall of the cathode tube 204. The filament 210 through the isolated support ring 208 locates in the cathode tube 204 When power is fed to the filament 210, the filament 210 generates thermal electrons which bombard the cathode tube 204 and thus produce secondary electrons e-. The secondary electrons e- bombard target atoms resulting in ions such as P+, P++ and P+++. A repeller plate 212 is used for preventing the secondary electrons form hitting the arc chamber and make more collisions of the secondary electrons e- with the target atoms.

The apparatus of the invention greatly increases the lifetime of the source head, and similarly reducing the downtime of ion implantation equipment. Since the support ring 208 is removable, it can be replaced during servicing of the arc chamber as desired. A reduction in the number of times an source head must be serviced not only increases the time between services, but also lessens the opportunity for faulty re-assembly, another cause of ion implant apparatus failure.

The support ring 208 enables a more efficient removal of the filament during servicing of the ion source chamber. Down time is reduced, and the filament and the support ring can be handled as a unit, thereby permitting faster replacement of the equipment, reducing the danger of misalignment of the filament during re-assembly, and preventing the short circuit of the filament to the cathode.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. An apparatus for preventing the short circuit of a filament of a source head to a cathode, comprising:
an arc chamber, having an opening;
a cathode tube, through said opening of said arc chamber extending in said arc chamber, one end of said cathode tube having a hollow, said hollow facing outside of said arc chamber;
an isolated support ring, locating in said hollow's sidewall of said cathode tube; and
a filament, through said isolated support ring locating in said cathode tube.

2. The apparatus as recited in claim 1, wherein a material of said isolated support ring is selected from the group consisting of glass, ceramic, polymer and combinations thereof.

3. The apparatus as recited in claim 1, wherein a shape of said isolated support ring is selected from the group consisting of cylinder, trigonometry, rhombus and irregular.

4. A method for preventing the short circuit of a filament of a source head to a cathode comprising the steps of:
providing an arc chamber having an opening;
providing a cathode tube, said cathode tube through said opening of said arc chamber extending in said arc chamber, one end of said cathode tube having a hollow, said hollow facing outside of said arc chamber;
providing an isolated support ring, locating in said hollow's sidewall of said cathode tube; and
providing a filament, through said isolated support ring and locating in said cathode tube.

5. The method as recited in claim 4, wherein a material of said isolated support ring is selected from the group consisting of glass, ceramic, polymer and combinations thereof.

6. The method as recited in claim 4, wherein a shape of said isolated support ring is selected from the group consisting of cylinder, trigonometry, rhombus and irregular.
